(19) United States
(12) Patent Application Publication
(10) Pub. No.: US 2010/0042498 A1
(43) Pub. Date: Feb. 18, 2010

(54) Criteria-Based Audio Messaging in Vehicles

(75) Inventor: Thomas Barton Schalk, Plano, TX (US)

Correspondence Address: MAYBACK & HOFFMAN, P.A., 5722 S. FLAMINGO ROAD #232, FORT LAUDERDALE, FL, 33330, US

(73) Assignee: ATX GROUP, INC., Irving, TX (US)

(21) Appl. No.: 12/541,496

(22) Filed: Aug. 14, 2009

Related U.S. Application Data
(60) Provisional application No. 61/089,148, filed on Aug. 15, 2008.

(51) Int. Cl. G06Q 30/00

(52) U.S. Cl. 705/14.52

(57) ABSTRACT

A method for delivering a criteria-based message to a vehicle occupant includes establishing a wireless communication session between a mobile device integral with a vehicle and a data center remote from the vehicle. Next, identifier of the vehicle and at least one criteria from the mobile device is communicated to the remote data center. The at least one criteria includes a statistic of the vehicle and/or a statistic of a user of the mobile device. Based on the at least one criteria, an advertisement message for communication to the mobile device is determined. Then, the determined advertisement message is communicated from the remote data center to the mobile device. In a further step, the advertisement message is output with a speaker fixed within the vehicle carrying the mobile device.

### CROSS-REFERENCE TO RELATED APPLICATION

This application claims the priority, under 35 U.S.C. §119, of copending U.S. Provisional Patent Application No. 61/089,148, filed Aug. 15, 2008; the prior application is herewith incorporated by reference herein in its entirety.

### STATEMENT REGARDING FEDERALLY SPONSORED RESEARCH OR DEVELOPMENT

n/a

### FIELD OF THE INVENTION

The present invention pertains to a method of delivering audio messages through a wireless connection to a vehicle. More particularly, the present invention pertains to a method of delivering audio messages that are triggered by criteria related to, for example, time, vehicle location, an event, a condition, mood-influencing intent, a tourist attraction, a user action, service reminders, and many more. The criteria-based messages are controlled by an automated voice-recognition system located at a remote data center and delivered through a wireless voice or data channel to the vehicle. The vehicle driver hears the audio message under various driving conditions. A voice user interface can be utilized by the vehicle driver to manage the audio messages.

### BACKGROUND OF THE INVENTION

Constant changes in culture and technology provide an ever-increasing array of avenues for one to reach customers or potential customers. These include, for example, television, radio, magazines, direct mail, signage, the INTERNET, including standard and interactive social websites, and mobile devices, which are providing more and more connectivity to the previously mentioned channels of communication.

Not long ago, the advertising industry was limited to a substantially lesser number of media channels from which to choose. However, over time, advertisers have taken advantage of each new media channel option that has developed. These new channels are now quite numerous and advertising strategies have become more creative than ever. The growing number of media channels can be attributed mainly to the above-mentioned advances in communication technology, including, for instance, better and more abundant access to information deliverable over the INTERNET, such as 3G mobile devices.

In addition, with geographic location determining features, such as the global positioning systems (GPS), included in advanced mobile devices, the mobile device medium has the potential to provide marketers with the ability to target customers based on their geographic location and to also utilize imaging. Although, multimedia advertisements (i.e., including visual components) have become a dominant message format, such a format is usually not appropriate for a vehicle driver from a safety perspective.

Because the average person spends a substantial amount of time in their vehicle, the automobile is a highly desirable media channel for delivering advertising. However, there are challenges with the user interface under driving conditions, especially because images displayed in the vehicle can distract the driver. Before trying to push advertising messages to the vehicle, one must understand the task of driving and to know that safety is a high priority. Driving is so basic to modern life that drivers no longer think of it as a complex task. However, driving requires constant focus as well a vast amount of physical coordination and analytical skills. In addition, the cognitive load of driving has increased over time. Increasing traffic levels, complex mixes of road systems (often subject to construction or constriction), and a much higher flow of information and infotainment to the vehicle make ordinary driving a very demanding challenge. Physically, every part of the body is involved in driving. Even today's most advanced vehicles still require hands on the wheel and feet ready for the accelerator and brake pedal.

With technological advances, driving is still largely a silent activity when it comes to tools and controls. Speech is not always an easy interface to use, especially in an automotive environment when others in the car are talking. If a car has a speech input, it is usually an optional interface mode because there can be technical challenges when trying to automatically recognize a driver or passenger's speech in a hands-free automotive environment.

There are two main modes of communicating information to a vehicle driver: auditory and visual. Over a brief period of time (e.g., a few minutes), humans can perceive much more information through vision than through hearing. However, the driver of a vehicle must apply visual concentration on driving and driver distraction must be minimized.

Therefore, a need exists to overcome the problems with the prior art as discussed above.

### SUMMARY OF THE INVENTION

The present invention is directed to a system, method, and process of delivering criteria-based audio messages from a remote data center database over a wireless link. The information delivered can be in the form of a short audio clip that is crafted carefully to give the desired effect on the vehicle driver. The messages are designed to be non-intrusive with a strong personality associated with the voices contained in the recordings. Such highly personified human recordings are triggered (initiated) based on one or a combination of different criteria including, but not limited to time, vehicle location, an event, a condition, a mood-influencing intent, a tourist attraction, or service reminders. An automated voice system located at the remote data center generates the audio messages.

A significant aspect of the invention disclosed here is that, in the audio domain, a service example can be more effective than a service description. After hearing a service example, people think of numerous other ways they could use the service. Analogous use cases are imagined in the driver's mind. The persona alone can influence mood. For example, imagine hearing a service demonstration portrayed by a combination of a male agent speaking to a female driver in a highly staged fashion. The service examples involve professional actors with voice characteristics that qualify them to be recording artists, which combines with the ability to speak quickly, clearly, and in a way that matches the goal of the scenario being acted out. The style of prompting used to describe a service is different from the style of prompting when acting out service example scenarios. For service examples, it is easier and more appropriate to exaggerate behavior, rather than remain somewhat monotonous, as is the case with service descriptions. Finally, the inventor's testing with human subjects clearly indicates that service examples, as described here, are far more effective than service descriptions in the context of influencing mood to buy while driving.

Flexibility is critical to delivering effective, up-to-date audio messages to vehicle drivers. All of the message recordings are conducted outside of the vehicle, typically at professional recording studios. The recordings are edited and concatenated in ways that enhance the affect on the driver and minimize driver distraction. For example, the messages should be short and to the point (less than 15 seconds, depending on the intent and scenario). In some cases, the driver requests to hear a service example (e.g., an acted out interaction between an agent and a driver) and, through a voice interface, the driver can elect to hear more or to stop the message at anytime.

It would be a significant advancement in the art to implement an automatic voice recognition system at a remote data center that would deliver audio messages from an off-board database over a wireless link to the vehicle driver in a hands-free environment. The primary advantages of the remote data center of the invention are flexibility and cost effectiveness. Because the platform is off-board, the application and message content can easily be modified without changing any in-vehicle hardware, or software. In terms of cost, server-based voice recognition resources can be shared across a large spectrum of different vehicles. For example, each channel of server-based voice-automation system could accommodate several vehicles simultaneously.

Locating the automated voice system at the remote data center provides substantial advantages over an embedded system inside the vehicle. The advantages include:
Increased operational flexibility and control from the call center;
Increased efficiency, since content can be added or modified with centralized hardware and/or software;
Improved scalability, since computer resources are shared across a large number of vehicles;
Usability improvement, to the extent that calls from the vehicles can be monitored and improvements made at the centralized location, rather than in the vehicles;
A “thin” client can be located in the vehicle using standard telematics control units, rather than a specialized on-board computer; and
The ability to connect a vehicle driver to a human agent that is able to activate a new service specific to the vehicle.

Wireless delivery of audio messages can also help automobile manufacturers and dealerships promote a vehicle's value-added features that often go unnoticed and unused by its owner. Because of the off-board implementation, content can be modified to highlight features the automobile manufacturer would like to promote. For that matter, recall notification could be managed efficiently through criteria related to remote diagnostics of the vehicle provided through telematics.

With the foregoing and other objects in view, there is provided, in accordance with the invention, a method for delivering a criteria-based message to a vehicle occupant, where the method includes establishing a wireless communication session between a mobile device integral with a vehicle and a data center remote from the vehicle. Next, identifier of the vehicle and at least one criteria from the mobile device is communicated to the remote data center. The at least one criteria includes a statistic of the vehicle and/or a statistic of a user of the mobile device. Based on the at least one criteria, an advertisement message for communication to the mobile device is determined. Then, the determined advertisement message is communicated from the remote data center to the mobile device. In a further step, the advertisement message is output with a speaker fixed within the vehicle carrying the mobile device. As used herein, a statistic is used in its most broadest sense as an item of information or data. It is not limited to a collection of data or to a numerical function used to describe a sample.

In accordance with another mode of the invention, the advertisement message includes a service example and/or a service description.

In accordance with a further mode of the invention, the service example includes a pre-recorded dialogue between at least two persons, the dialogue providing information pertaining to features of a product and/or a service.

In accordance with an added mode of the invention, the service example mimics a live service interaction between a vehicle driver and a remote data center human agent.

In accordance with an additional mode of the invention, the at least one criteria includes a time of day, a time of year, and/or a season.

In accordance with yet a further mode of the invention, the at least one criteria includes a task progress, a scheduled event, a geographic location of the vehicle, and a condition of the vehicle.

In accordance with again a further mode of the invention, the method further includes the steps of accepting an interrupt command from the mobile device, halting the output of the advertisement message in response to accepting the interrupt command, and initiating a driver assist query.

In accordance with yet a further feature of the invention, the establishing a wireless communication is initiated by a telematics request.

Other features that are considered as characteristic for the invention are set forth in the appended claims.

Although the invention is illustrated and described herein as embodied in system, method, and process of delivering criteria-based audio messages from a remote data center database over a wireless link, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

Advantages of embodiments of the present invention will be apparent from the following detailed description of the preferred embodiments thereof, which description should be considered in conjunction with the accompanying drawings in which:

FIG. 1 is a block diagram of a mobile communication system in accordance with the present invention;

FIG. 2 is a block diagram of a control center in accordance with the present invention; and

FIG. 3 is a flow diagram illustrating a process of utilizing the present invention.

### DETAILED DESCRIPTION OF THE INVENTION

Aspects of the invention are disclosed in the following description and related drawings are directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. It must be noted that, as used in the specification and the appended claims, the singular forms “a,” “an,” and “the” include plural references unless the context clearly dictates otherwise.

While the specification concludes with claims defining the features of the invention that are regarded as novel, it is believed that the invention will be better understood from a consideration of the following description in conjunction with the drawing figures, in which like reference numerals are carried forward. The figures of the drawing are not drawn to scale.

The present invention provides a system and method for delivering information to a vehicle where the information is related, at least partially, to a particular criteria pertaining to the vehicle or driver. This criteria can include vehicle location, time of day, time of year, weather conditions, vehicle driver information, vehicle diagnostic information, vehicle-specific information (e.g., make, model, year, type, vehicle repair history and vehicle repair schedule), and many other pieces of information. Embodiments of the present invention provide a plurality of information types, such as sales and other commercial offers, and criteria used to determine which type will be transmitted and to whom, where, and at what time.

When one or more statistics associated with either the vehicle, the driver, or both, is known, the statistic(s) is compared to the criteria associated with each message and an advertisement message is transmitted to the vehicle for playback over the vehicle's audio system. In accordance with inventive aspects of the present invention, the driver could be given a choice of how the informational message is heard. This choice includes hearing a service description versus a service example. A service description is just that—details of the service are described to the driver in an effort to interest the driver and encourage the driver to purchase the service. A service example provides a dialogue, usually between two people, illustrating an example of how the service can be used. The voice application design of the present invention encourages the driver, or any other occupant within the vehicle, to listen to a service example, which can be randomly selected, instead of a service description. Research has shown that service examples are far more effective at selling than a less enjoyable service description. Embodiments of the present invention can feature multiple personas that add to the effectiveness of the up-selling technique.

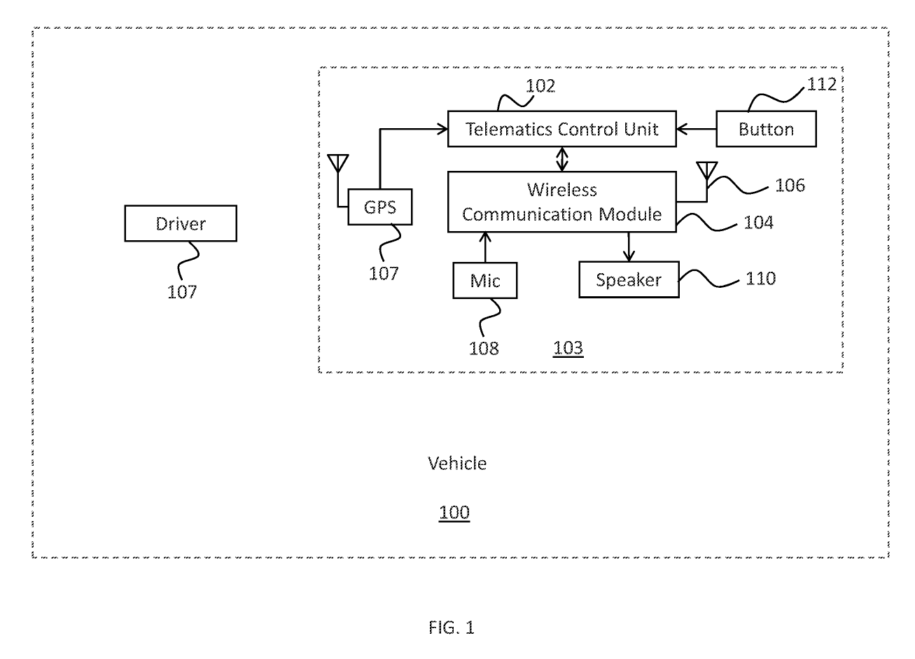

Referring now to FIG. 1, a block diagram of a representative system for delivering criteria-based messaging according to embodiments of the present invention is shown. A vehicle 100, which includes any vehicle capable of movement, is operated by a driver 101. The vehicle 100, according to one embodiment, is provided with a telematics system 103 that includes a telematics control unit 102, a wireless communication module 104, an antenna 106, a GPS receiver 107, a microphone 108, a speaker 110, and a user input 112, such as a button.

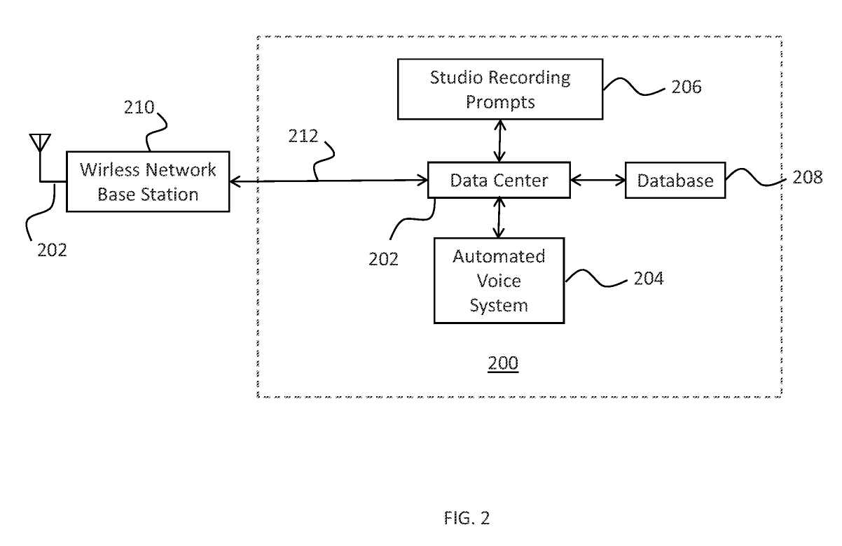

There are a number of exemplary uses for a telematics system 103. One exemplary use is the most commonly found use of a telematics system—to summon roadside assistance. For the present example, the entity supplying the telematics system 103 has live operators at a remote facility, e.g., at a control center 200, shown in FIG. 2, for providing roadside assistance through a voice communication. Further, the user input 112 is operable to call the control center 200 upon a single actuation. For example, the telematics system 103 can have a red “emergency” button that, when pressed, opens a communications channel to the operator. Accordingly, when the vehicle occupant presses the button, the appropriate software is called up to enable a “live-operator-communication.”

If, as shown in FIG. 1, the telematics system 103 has an embedded GPS system 106, the data sent to the control center 200 can include current GPS location coordinates. In this way, the operator can be provided with the information pinpointing the vehicle's location before voice communication occurs between the operator and the occupant.

Roadside assistance is only one of the possible telematics functions that could be provided with the inventive telematics system 103 of the present invention. Another function that could be provided with the telematics system 103 is a door-unlock command. If the telematics system 103 is communicatively coupled with the device that unlocks a locked door of the vehicle, then the telematics system 103 can interface and actuate the door-unlocking device. If the telematics system 103 is similarly connected to the vehicle starting assembly, then the telematics system 103 can effect a remote engine start with little added difficulty. Likewise, if the telematics system 103 has access to the vehicle's diagnostics bus, then any available diagnostic status can be made accessible not only to the driver, but also to an operator at the control center 200. In an emergency, where the driver/passenger(s) is not available, the telematics system 103 can be programmed to automatically send a diagnostics state(s) to the control center 200.

It should be noted that at least part of the telematics system 103 is integrated with the vehicle. Here, integrated or integral means that part of the system 103 is at least semi-permanently attached to the vehicle or parts of the vehicle. That is, integral or integrated does not describe devices, such as cellular phones, which can easily be carried into and out of a vehicle. In some embodiments of the present invention, the telematics system 103 is not supplied by the original equipment manufacturer, but is, instead, an aftermarket device. However, once the aftermarket device is permanently or semi-permanently connected to the vehicle's wiring (i.e., diagnostic data wiring), the aftermarket telematics device becomes “integral” with the vehicle. In each case, the integrated telematics system 103 is embodied in at least one physical component of the system 103 (i.e., a telematics “device”) present at the vehicle that is physically accessible and/or visible to an occupant within the vehicle. The telematics device houses at least one component of the above-describe telematics system 103 and is in communication with the other components of the system 103. For instance, at least the button 112 is physically accessible by an occupant of the vehicle and generally, one or more lights will be visible within the vehicle's interior. Pushing the button 112 will cause one or more of the other system components to operate.

FIG. 2 shows block diagram of an exemplary remote control center 200. The control center 200 includes a data center 202, an automated voice system 204, studio recording prompts 206, and a database 208. The control center 200 receives communication signals from the vehicle 100 over a communication link 212 that is connected to a wireless network base station 210.

In the context of the present invention, a data center 202 is substantially a highly automated call center that is aimed at providing telematics services. The data center 202 communicates with vehicles through voice and data channels and is capable of managing a variety of vehicle-centric functionality, including vehicle emergencies. Live agents and automated voice systems 204 are components of the data center. In one embodiment of the present invention, the type of data communicated to and from the vehicle includes, for instance, information related to vehicle location, diagnostic data, driver requests, and other vehicle-centric functionality. The voice-automated system 204 communicates with a vehicle driver much like a live agent would, although when emergencies are involved, calls are routed to live agents whenever possible. Voice automated systems 204 play audio prompts to the vehicle driver that are recorded at a studio, usually by professional talent (high quality voices). In many cases, text-to-speech engines generate the audio prompts and yield a lower quality of speech as heard by the driver. Text-to-speech can be used in place of studio prompts to save on cost, but human recordings are preferred for most applications.

The off-board automated voice system 204 and the other components shown in FIG. 2 are advantageous to the present invention. The intelligence behind the presently-inventive message criteria system is shared between the on-board and off-board components, but the major computing is performed at the control center 200, where more computing power is available than on the vehicle. Updates can be performed to the off-board components much easier than identifying and accessing the many mobile units utilizing the inventive system.

For an outgoing message from the control center 200 to the vehicle, the criteria-based audio messages are managed and transmitted by the automated voice system 204, then are passed through the data center 202, through one of many available telecommunications networks 212, through the wireless network base station 210, over a wireless link to the vehicle 100, through the vehicle mounted wireless antenna 106, through the vehicle mounted wireless communication module 104, and finally broadcast on the vehicle's speaker(s) 110 in a hands-free environment.

When a vehicle driver 101 initiates a telematics connection, the vehicle driver's spoken commands pass through the vehicle microphone 108, through the vehicle-mounted wireless communication module 104, through the vehicle mounted wireless antenna 106, over a wireless link 212, through the wireless network's antenna 214 and wireless network base station 210, through one of many available telecommunications networks 212, and into the data center 202, which is connected to the automated voice system 204.

Once the command arrives, the automated voice system 204 interprets the spoken command(s). Depending on the nature of the telematics request from the vehicle driver 101, the vehicle driver 101 can, for example, select a menu item, request to subscribe to a service, abort the session, command the system to perform any number of telematics tasks, or many other selectable options.

The telematics request can be accomplished automatically or by pressing the button 112 and speaking a command that is detected by the microphone 108 within the vehicle 100. When a telematics connection is established between the vehicle 100 and control center 200, information is exchanged between the vehicle 100 and the control center 200. This information can include vehicle location, vehicle model information, vehicle driver information, diagnostic information, and other information, all referred to as “statistics” herein. Some information may be known prior to the driver 101 pushing the button 112 and some statistics are captured at the time or after the button 112 is pushed. It should be noted that pushing a button is only one exemplary way to cause the system to initiate a functional state and other methods, such as speaking a particular word, are contemplated by the present invention.

After communication between the vehicle 100 and control center 200 is established, the vehicle driver 101 hears audio prompts through the speaker 110. The speaker 110 can be the vehicle's factor equipped speakers or can be aftermarket add-on speakers, preferably located in proximity to the vehicle driver 101. Depending on conditions at the time of the telematics service request (i.e., the button push), the vehicle driver 101 may or may not hear an audio message.

As just one example of the present invention, a vehicle driver is exposed to an audio message when it is determined that the vehicle's location is within a specified radius surrounding the location of an upcoming event that is scheduled to occur. The intent of the message could be to promote the event to the driver with a short audio message that is played inside the vehicle using audio equipment located therein, such as speaker 110. More specifically, if the event were, for instance, a sale at a car dealership, the car dealer would register the event with the control center 200 in advance and provide information relevant to the sale. The dealer could also select criteria prerequisites which the control center 200 would then use to filter potential message recipients based on their statistics within particular criteria categories. For instance, if the dealership was a MERCEDES dealership, one criteria could be whether or not a person is a current owner of a MERCEDES vehicle. A statistic would be the year or model of the MERCEDES. Therefore, as an example, a dealership could specify: 1) that the sale would be announced only to drivers of MERCEDES vehicles; 2) only to drivers of MERCEDES vehicles manufactured more than five years prior; and 3) only to drivers of MERCEDES vehicles manufactured more than five years prior that are currently within five miles of the dealership.

In some cases, the audio message will reference the event and provide directions and other information that will allow the user to attend the event either immediately or at a later date. In addition, the message may indicate that an email with details will be sent to the driver. This communication lets the driver know to expect the message, hopefully making the driver more willing to read it once he or she sees it in his or her inbox. In the email scenario, the driver is assumed to be a current service subscriber and the remote message center would have access to customer data, such as an email address.

Examples of telematics services are virtually unlimited, but include, from a remote center 200 to a driver 101, provision of directions, location of nearby stores, restaurants, parks, highways, etc., placing reservations for the driver, directing emergency services to the vehicle's location, and the provision of many more services. In addition, the telematics system 103 is connected to multiple sensors throughout the car. Advantageously, the telematics system 103 is able detect a large number of attributes of the vehicle at any time. The attributes include the condition of the vehicle, such as the vehicle's diagnostic information (e.g., engine statistics), orientation of the vehicle (e.g. the car is upside down), whether airbags have deployed, whether the oil needs to be changed, if the car is mobile without a seatbelt connected, and many more. Each of these attributes can be transmitted to the remote data center and can be the subject of a criteria-based message.

In embodiments of the present invention where a telematics request is initiated by the button 112, a criteria-based message could be delivered after the driver pushes the button 112, but before the telematics request is delivered to the driver. In other words, the actual telematics request could be fulfilled after a short audio message is delivered to the driver. For example, if the vehicle driver 101 pushed the telematics button 112 for the purpose of getting driving directions from a call center agent, the criteria-based audio message would occur first. Embodiments of the present invention also provide for an interrupt feature where the driver 101 can halt the output of the message and jump to whatever driver assist query he or she was seeking.

Another example of criteria-based messaging involves service promotion, or up-selling. For example, a vehicle driver 101 may initiate a telematics request by pushing the button 112 inside the vehicle 100. Although the button 112 is referred to herein in the singular, the button 112 can be multiple buttons. Examples of such buttons 112 include an SOS button, an information button, a concierge button, or a roadside button. Depending on conditions at the time of the telematics service request, the vehicle driver may or may not hear a criteria-based audio message. For illustration purposes, assume that the vehicle driver 101 pushes a concierge button, but the driver is not a subscriber to the concierge service. A dialogue would be initiated by the voice automation system 204 and prompting would occur with the intent of up-selling the vehicle's driver 101 by transforming the mood of the driver 101 into a buying mode.

As another example, a criteria-based message may be initiated by an upcoming or past expiration of a user's subscription to a service. In addition, a newly available subscription could be the subject the initiates a message being broadcast to a driver.

Criteria-based messaging can also be used to inform a driver that a new location-based service is available. A traffic report is just one example of a service that is only available and relevant in certain locations, such as metropolitan areas. Traffic reports are not available or considered as important in many regions where traffic is sparse. A vehicle driver may be in an area that has grown in population to the extent that traffic can be an issue. As new traffic services become available, criteria-based audio messaging can be used to inform drivers that traffic information is available in their immediate area, identified by the GPS component 107, or an area that the GPS component 107 has identified that vehicle as traveling through at least once. Depending on a vehicle's location at the time of a telematics service request, the vehicle driver may hear a criteria-based audio message indicating that traffic service is now available.

Likewise, there may be a new facility or tourist attraction that could be advertised to a vehicle driver based on vehicle location. Again, a telematics request could be fulfilled after a short audio message is delivered to the driver.

As an additional example, criteria-based audio messages may be triggered based on seasonal changes. As just one example, many vehicles need special attention before winter begins, depending on their location of use. Upon pressing the button 112, a message may be played that announces a particular business's products, e.g. snow tires, that are specific to a season (a first criteria) and the type of vehicle (a second criteria). Many other criteria can be utilized as well, such as the vehicle's normal driving area (determined via GPS 107), previous purchases or services performed on or to the vehicle, and many others.

As a further example of the advantageous features of the present invention, suppose a car salesperson is showing a vehicle to a potential buyer and wishes to demonstrate the advantageous feature of telematics system equipped on the vehicle. The salesperson can instruct the potential buyer to press the button 112, which initiates a call to the control center 200, which, in turn, determines whether the particular car is currently subscribed to the service (a criteria). If the unit is not identified as a currently subscribing vehicle, the control center 200 can initiate a demonstration service example in an effort to both educate the potential buyer, as well as entice the buyer to purchase the vehicle and to subscribe the inventive service. The following is an exemplary service example that can take place and educate as well as entertain the potential purchaser, or anyone else listening to the advertising message. Note that the following example dialogue between two people is an example of a prerecorded dialogue and that the potential purchaser or any other person at the vehicle side are listening to and are not participating in the dialogue.

### EXAMPLE

Female voice: Telematics service center. How may we be of assistance?
Male voice: Today is my anniversary and I would like to have flowers delivered to my wife.
Female voice: Happy anniversary! I can certainly help you with that. What type of flowers were you looking for and where would you like them delivered.
Male voice: I was thinking of a dozen long stem roses. My wife's address at work is 3232 Main Street, Suite 123, so if they could be delivered before she leaves at 6:00, that would be great. Her name is Susie Smith.
Female voice: No problem Mr. Smith. I have located a flower shop near this address. When we finish this call, I will connect you directly with the shop. Is there anything else I can help you with?
Male voice: There is. I would like to take her to a nice dinner tonight. What are some good restaurants downtown?
Female voice: I have located quite a few highly rated restaurants in that area, what type of food are you looking for?
Male voice: A good steak restaurant sounds nice.
Female voice: I have located Restaurant X, which received five stars in our latest restaurant review. Would you like me to make reservations for you?
Male voice: Yes, please. I would like them for 7:00.
Female voice: Please hold for a second. Okay, your reservations have been made and are under your name. Would you like to have a bottle of Champagne on ice at the table when you arrive?
Male voice: Wow, that would be great!
Female voice: I will take care of that for you. Is there anything else I can help you with today?
Male voice: No, thank you so much.
Female voice: It was our pleasure. I will now connect you with the flower shop. Have a great evening!

The service example, such as the one above, is believed to be much more interesting to the listener than a simple prerecorded description of available features, which tend to be monotone and lack emotions. The above exemplary dialogue is not limited to potential purchases and can be played to owners of cars equipped with the present invention whether they are subscribers or not. In one embodiment, the invention can provide a system for tracking service examples or descriptions that have been demonstrated and ensures that these same advertising messages are not repeated to the same vehicle driver. The prerecorded service examples are an advantageous way to educate subscribers or non-subscribers of the types of services available. It allows dialogues to be played out without requiring live operators to speak to each person. However, the invention is in no way limited to pre-recorded messages and, in some cases, live operators can perform the service examples. It is envisioned that, prior to subscribing to the service, only pre-recorded messages will be available to the driver.

As previously stated, when delivering criteria-based messages, it is believed that service examples are more attractive to listeners and more effective at conveying a service's features. In addition, when considering potential audio prompts that a listener hears when using an automated voice applications, one goal has been to make the user's experience better by completing the caller's task in a time-efficient manner, making it less likely that a caller will request conversation with a human. Over time, automated applications have become more human-like with signs of reaching natural language. Callers can even relate to an automated “persona,” as speech vendors have been calling the implied personality of the automated system. There is an opportunity to involve the caller emotionally, even to entertain by humor, for example, and to make the call a pleasant experience. Even if a dialogue designer does not attempt to create human-like qualities, the caller will intuitively assign them to the automated persona. If used properly, this characteristic can make audio messages to the vehicle very effective.

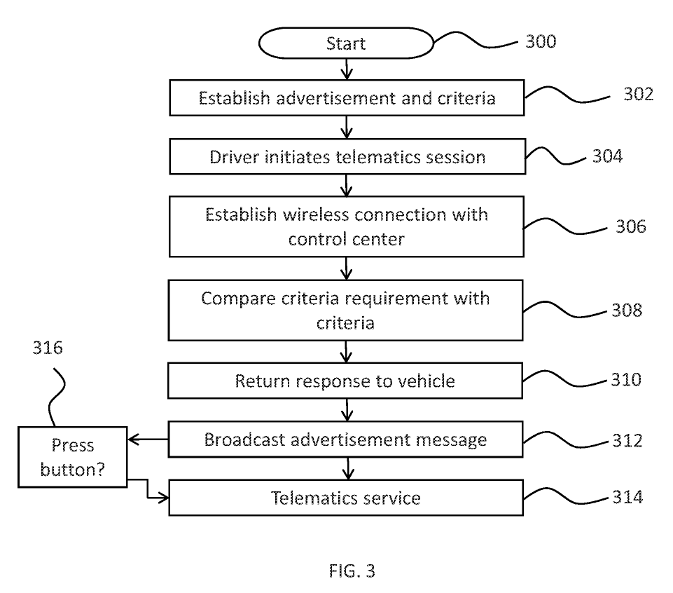

FIG. 3 shows an exemplary process for performing the inventive method in accordance with embodiments of the present invention. The process starts at step 300 and moves directly to step 302 where at least one advertisement is established, the advertisement having at least one criteria requirement associated therewith. “Establishment” can mean the actual recording of the advertisement and the “criteria requirement” can indicate factors that determine who is to hear the recorded message and when they should hear it. The criteria requirement includes prerequisite statistics that are to be met before the advertisement should be transmitted to a particular vehicle. In step 304, a driver 101 initiates a telematics feature within a vehicle 100. For instance, the driver 101 can press the button 112 within the car. In step 306, the in-car equipment initiates a communication session over a wireless link 212 to a remote control center 200. Included in this communication of step 306 is at least one statistic pertaining to at least one criteria. This includes, for example, information pertaining to the vehicle to which the equipment is attached, the vehicle's location, whether the driver is a subscriber or not, and many others. In step 308, the control center 200 compares the at least one criteria requirement to the at least one criteria. Based on this comparison, the control center returns a response to the vehicle 100 in step 310. The response, in one embodiment, is an automatically determined advertising message based on one or more of the identified criteria and associated statistics. The message, for instance, is an advertising message attempting to persuade the listener to take an action. In step 312, the advertisement message is broadcast to the driver. In step 314, after the criteria-based message has finished playing in step 312, the system allows the driver 101 to carry out his or her desired use of the telematics service. At any time during step 312, the user can push a button (step 316) to interrupt the playing of the message and the process will immediately jump to step 314.

A method and process of delivering criteria-based audio messages through a wireless connection to a vehicle has been described. The present invention pertains to a method and system for delivering audio messages that are stored off-board, and triggered by conditions related to criteria, such as time, vehicle location, an event, a condition, a mood-influencing intent, a tourist attraction, or service reminders. The criteria-based messages are controlled by an automated voice recognition system located at a remote data center and delivered via a wireless voice, or data channel to the vehicle. The vehicle driver and/or passengers hear the audio message under various driving conditions. A voice user interface is utilized by the vehicle driver to manage the audio messages. The invention further includes methodology for pushing audio messages to a vehicle in a highly controlled fashion and in a way that does not interfere with the task of driving. The present invention further includes techniques for designing audio messages that match the intent associated with the criteria required to trigger the deliverer of the audio message.

Although the foregoing specific details describe a preferred embodiment of this invention, persons reasonably skilled in the art of wireless data communication and/or voice recognition technology will recognize that various changes may be made in the details of the method and apparatus of this invention without departing from the spirit and scope of the invention as defined in the appended claims. Therefore, it should be understood that this invention is not to be limited to the specific details shown and described herein. The above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for delivering a criteria-based message to a vehicle occupant, the method comprising:
establishing a wireless communication session between a mobile device integral with a vehicle and a data center remote from the vehicle;
communicating an identifier of the vehicle and at least one criteria from the mobile device to the remote data center, the at least one criteria including at least one of a statistic of the vehicle and a statistic of a user of the mobile device;
determining, based upon the at least one criteria, an advertisement message for communication to the mobile device;
communicating the determined advertisement message from the remote data center to the mobile device; and
outputting the advertisement message with a speaker fixed within the vehicle carrying the mobile device.

2. The method according to claim 1, wherein the advertisement message comprises at least one of:
a service example; and
a service description.

3. The method according to claim 2, wherein the service example comprises:
a pre-recorded dialogue between at least two persons, the dialogue providing information pertaining to features of at least one of a product and a service.

4. The method according to claim 2, wherein:
the service example mimics a live service interaction between a vehicle driver and a remote data center human agent.

5. The method according to claim 1, wherein the at least one criteria comprises at least one of:
a time of day;
a time of year; and
a season.

6. The method according to claim 1, wherein the at least one criteria comprises at least one of:
a task progress;
a scheduled event;
a geographic location of the vehicle; and
a condition of the vehicle.

7. The method according to claim 1, further comprising:
accepting an interrupt command from the mobile device;
halting the output of the advertisement message in response to accepting the interrupt command; and
initiating a driver assist query.

8. The method according to claim 1, wherein the establishing a wireless communication is initiated by a telematics request.

9. A method for delivering a criteria-based message to a driver, the method comprising:
determining at least one advertisement message;
associating at least one prerequisite with the at least one advertisement message;
wirelessly receiving, at a remote data center, from a mobile device integrated within a vehicle:
a telematics request;
an identifier of the vehicle; and
at least one criteria, the at least one criteria including at least one of a statistic of the vehicle and a statistic of a user of the mobile device;
comparing the at least one prerequisite to the at least one criteria; and
communicating the determined at least one advertisement message from the remote data center to the mobile device if the at least one criteria matches the at least one prerequisite.

10. The method according to claim 9, wherein the advertisement message comprises at least one of:
a service example; and
a service description.

11. The method according to claim 10, wherein the service example comprises:
a pre-recorded dialogue between at least two persons, the dialogue providing information pertaining to features of at least one of a product and a service.

12. The method according to claim 10, wherein:
the service example mimics a live service interaction between a driver of the vehicle and a remote data center human agent.

13. The method according to claim 9, wherein the at least one criteria comprises at least one of:
a time of day;
a time of year; and
a season.

14. The method according to claim 9, wherein the at least one criteria comprises at least one of:
a task progress;
a scheduled event; and
a geographic location of the vehicle.

15. The method according to claim 9, further comprising:
accepting an interrupt command from the mobile device;
halting the output of the at least one advertisement message in response to accepting the interrupt command; and
initiating a driver assist query.

16. A method for delivering a criteria-based message to a driver, the method comprising:
establishing a plurality of advertisements, each advertisement having at least one criteria requirement associated therewith;
establishing a wireless communication link between a mobile device integral with a vehicle and a data center remote from the vehicle;
receiving at the remote data center an identifier of the vehicle and at least one criteria, the at least one criteria including at least one of a statistic of the vehicle carrying the mobile device and a statistic of a user of the mobile device;
comparing the at least one criteria requirement to the at least one criteria; and
communicating at least one of the plurality of advertisements to the mobile device if the at least one criteria matches the at least one criteria requirement.

17. The method according to claim 16, wherein at least one of the plurality of advertisements comprises at least one of:
a service example; and
a service description.

18. The method according to claim 17, wherein the service example comprises:
a pre-recorded dialogue between at least two persons, the dialogue providing information pertaining to features of at least one of a product and a service.

19. The method according to claim 17, wherein:
the service example mimics a live service interaction between a driver of the vehicle and a remote data center human agent.

20. The method according to claim 16, wherein the at least one criteria comprises at least one of:
a time of day;
a time of year; and
a season.

21. The method according to claim 16, wherein the at least one criteria comprises at least one of:
a task progress;
a scheduled event;
a geographic location of the vehicle; and
a condition of the vehicle.

22. The method according to claim 16, further comprising:
accepting an interrupt command from the mobile device;
halting the output of the at least one of the plurality of advertisements in response to accepting the interrupt command; and
initiating a driver assist query.
